(19) United States
(12) Patent Application Publication
(10) Pub. No.: US 2006/0059037 A1
(43) Pub. Date: Mar. 16, 2006

(54) Local enforcement of remotely managed parking payment systems

(76) Inventors: James Darryl Ivey, Oakland, CA (US); Thomas Janacek, Calgary (CA)

Correspondence Address: JAMES D IVEY, 3025 TOTTERDELL STREET, OAKLAND, CA, 94611-1742, US

(21) Appl. No.: 10/938,413

(22) Filed: Sep. 10, 2004

(51) Int. Cl. G07B 15/00; G07B 15/02

(52) U.S. Cl. 705/13; 705/1

(57) ABSTRACT

A parking payment status map represents payment status of multiple parking locations as recorded on a parking management computer system. The map is retrieved by a parking control officer through a wireless communications network from the parking management computer system. The parking control officer can therefore verify payment status of multiple parking locations simultaneously. The map can be viewed on standard web browsers. User-interface controls enable user-controlled panning, rotation, and refreshing of the parking payment status map.

### FIELD OF THE INVENTION

This invention relates to the field of computer-implemented parking payment status displays, and more specifically to a particularly efficient graphical representation and intuitive user interface by which a parking control officer can verify remotely administered payment of parking fees.

### BACKGROUND

A number of efforts have been made to enable cashless payment for parking. One is the use of a mobile phone to pay for parking in a lot. Such a system is provided by Verrus, Inc. of Vancouver, British Columbia, Canada. Payments by mobile phone generally involve a server computer system which receives messages from motorists. These messages generally inform the server that payment for parking by the motorist has begun or has terminated.

Enforcement in such a system requires generally remotely querying the server computer system and verifying payment status of an individual vehicle. Such typically requires a parking control officer to contact the server computer system and manually enter an identifier of the vehicle such as a license plate number—which is generally an alphanumeric string. Such manual entering of vehicle identifiers of every parked vehicle renders such remotely administered payment systems unusable.

What is lacking is a satisfactory mechanism by which parking control officers can easily and efficiently retrieve information regarding current parking payment status from such a server computer system.

### SUMMARY OF THE INVENTION

In accordance with the present invention, the parking control officer receives a map representing parking status of multiple parking locations simultaneously. The map is received from a server computer system on a client device held by the parking control officer. Individual parking locations are both identified and represented in spatial relation to other parking locations such that a parking control officer can readily match multiple parking locations represented on the map with respective actual parking locations in the parking control officer's presence. The respective parking status of the individual parking locations are also represented in the map. The parking control officer can therefore easily and readily view the parking status of multiple parking locations in a general area.

The parking status generally includes a paid state and an unpaid state. For example, paid locations are represented in green and unpaid locations are represented in red. Of course, other display characteristics can be varied to represent the different states of the various parking locations. The parking control officer can immediately identify parking locations which are indicated as unpaid in the vicinity. By visual observation of any parking meters in the vicinity, the parking control officer can verify that parking locations which are indicated in the map to be unpaid have paid using cash or other payment accepted by the parking meter. Thus, conventional coin-operated parking meters can coexist with the payment verification system according to the present invention. In other words, conventional coin-operated parking meters can be used to control parking for the same parking locations for which parking can be paid using a mobile telephone and verified in the manner described herein.

The map can be composed in a format which can be sent by a web server and displayed by a conventional web browser. For example, the map can be composed of images and/or hypertext markup language (HTML).

To specify an initial vicinity of interest around which an initial map is composed, the parking control officer enters an identifier of an individual parking location. The parking control officer can request that the map be moved up or down, rotated left or right, or refreshed.

### BRIEF DESCRIPTION OF THE DRAWINGS

FIG. 1 shows a hand-held computer which shows a parking status map in accordance with the present invention.

FIG. 2 shows the hand-held computer of FIG. 1 in greater detail.

FIG. 3 shows the parking status map of FIGS. 1 and 2 in greater detail.

FIG. 4 is a block diagram of the hand-held computer of FIGS. 1 and 2 in greater detail.

FIG. 5 is a block diagram showing the hand-held computer of FIGS. 1 and 2 in communication with a server computer system through a wide area network.

FIG. 6 is a block diagram showing the server computer system of FIG. 5 in greater detail.

FIG. 7 is a block diagram showing a parking event record of FIG. 6 in greater detail.

FIG. 8 is a block diagram showing a parking space record of FIG. 6 in greater detail.

FIG. 9 is a logic flow diagram showing the presentation of the parking status map of FIG. 3 to the parking control officer in accordance with the present invention.

FIG. 10 is a logic flow diagram showing a user interface associated with the parking status map in accordance with the present invention.

FIG. 11 shows an alternative parking status map which is displayable on text-only displays.

### DETAILED DESCRIPTION

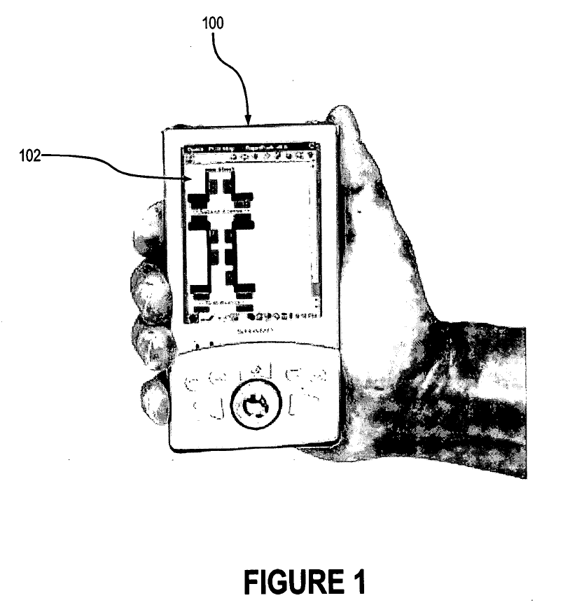

In accordance with the present invention, a parking payment status map 100 (FIG. 1) is presented on a display of a hand-held computer 102 carried by a parking control officer. Parking payment status map 100 includes spatially related representations of parking spaces and such representations indicate a paid or unpaid state of each represented parking space. Accordingly, the parking control officer receives parking payment status for multiple parking spaces simultaneously.

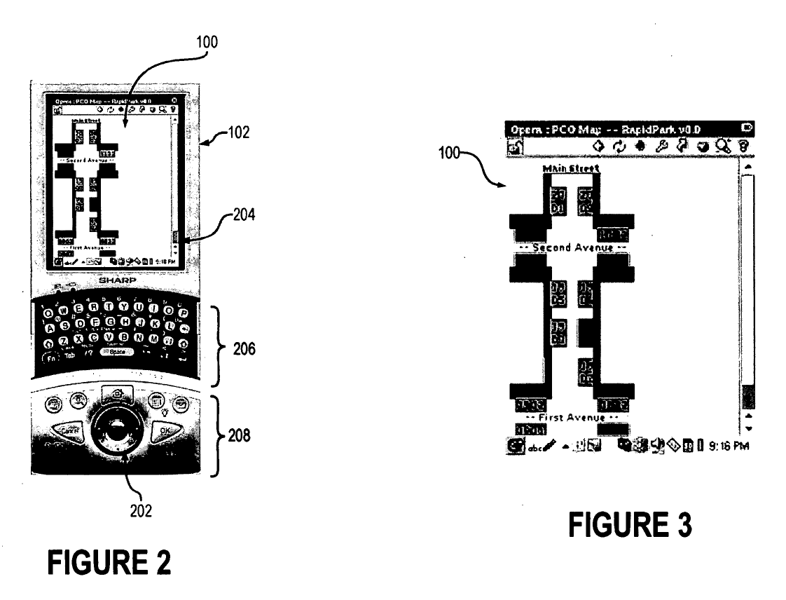

Parking payment status map 100 is displayed on a touch-sensitive screen 204 (FIG. 2) of hand-held computer 102. Hand-held computer 102 includes a number of user input devices, namely, thumb keyboard 206 and buttons 208. Of course, touch-sensitive screen 204 is also a user input device. Buttons 208 includes a rocker button 202 which can be actuated in at least 5 different directions: up, down, left, right, and center. As shown, hand-held computer 102 is the Zaurus SL-5500 hand-held computer available from Sharp Electronics.

As shown in FIG. 3, parking payment status map 100 shows numbered parking spaces in the vicinity of Main Street at First and Second Avenues. Spaces shown in green are paid. Spaces shown in red are unpaid. Specifically, on Main Street, spaces 1902, 1903, 1905, 1906, 2001, and 2002 are paid while space 1904 is unpaid. On First Street, spaces 0832, 0901, and 0902 are paid while space 0832 is unpaid. On Second Street, space 1132 is paid while spaces 1131, 1201, and 1202 are unpaid. Space 1904 and other spaces shown as unpaid in parking payment status map 100 may be paid by placing coins in a meter at that space. The parking control officer viewing parking payment status map 100 can verify such payment by observing the parking meter stationed at each parking space in a conventional manner.

Parking payment status map 100 also includes color coding of curbs to show special parking zones. For example, the space across Main Street from space 1902 is in a red zone in which parking is not permitted. The curb at that space is shown in red in parking payment status map 100 to represent the red zone to the parking control officer. In addition, the curb at space 2002 is shown in blue to indicate a parking space reserved for handicapped persons. In this illustrative embodiment, parking space 2002 is always shown as paid (e.g., in green) since handicapped persons are generally not charged for parking. In an alternative embodiment, space 2002 is omitted altogether (leaving an empty space by the blue curb) to indicate that payment is not required for that space.

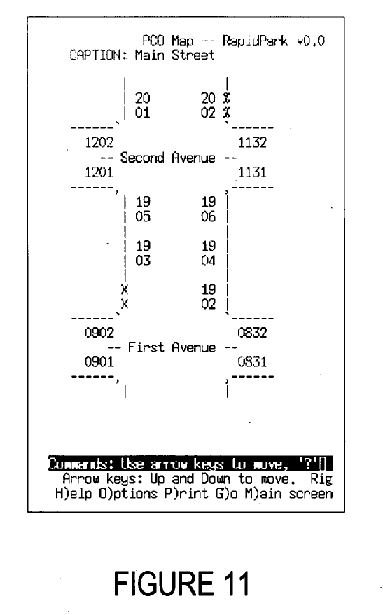

FIG. 11 shows a version of parking payment status map 100 displayed by a text-only browser such as the well-known lynx web browser typically distributed with many distributions of the Linux operating system.

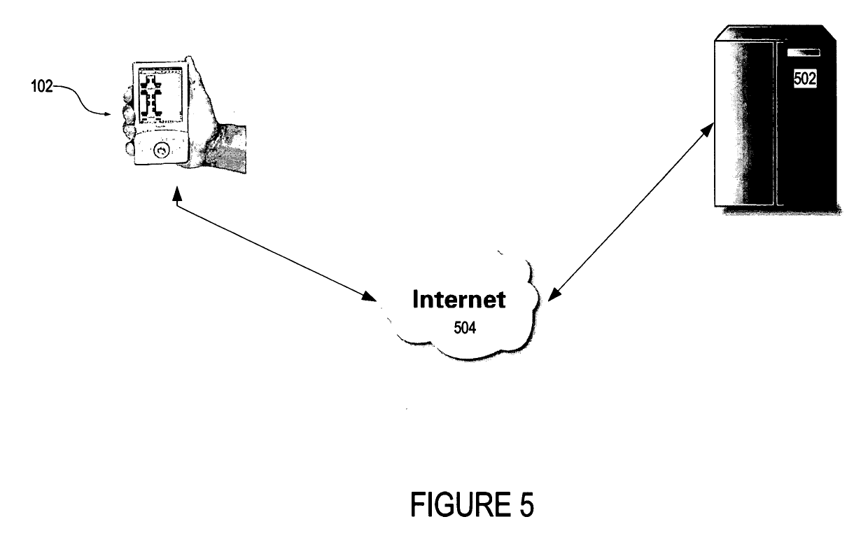

Hand-held computer 102 retrieves parking payment status map 100 through a wide area network 504 (FIG. 5) from a server 502. Server 502 serves remote requests for payment for parking and therefore includes data representing the current paid or unpaid status of each parking space. In this illustrative embodiment, wide area network 504 is the Internet. Also in this illustrative embodiment, server 502 implements an interactive voice response (IVR) interface by which a motorist identifies a particular parking space and can initialize and terminate payment for parking at the identified parking space.

Hand-held computer 102 communicates wirelessly through Internet 504, e.g., using GPRS, in this illustrative embodiment. In an alternative embodiment, hand-held computer 102 communicates wirelessly with a computer stationed in a vehicle used by the parking control officer, e.g., using a wireless communication of lesser range such as BlueTooth or any of the 802.11 protocols generally referred to as Wi-Fi. The computer stationed in the vehicle communicates with server 502 by a longer range wireless communications protocol such as GPRS or two-way paging.

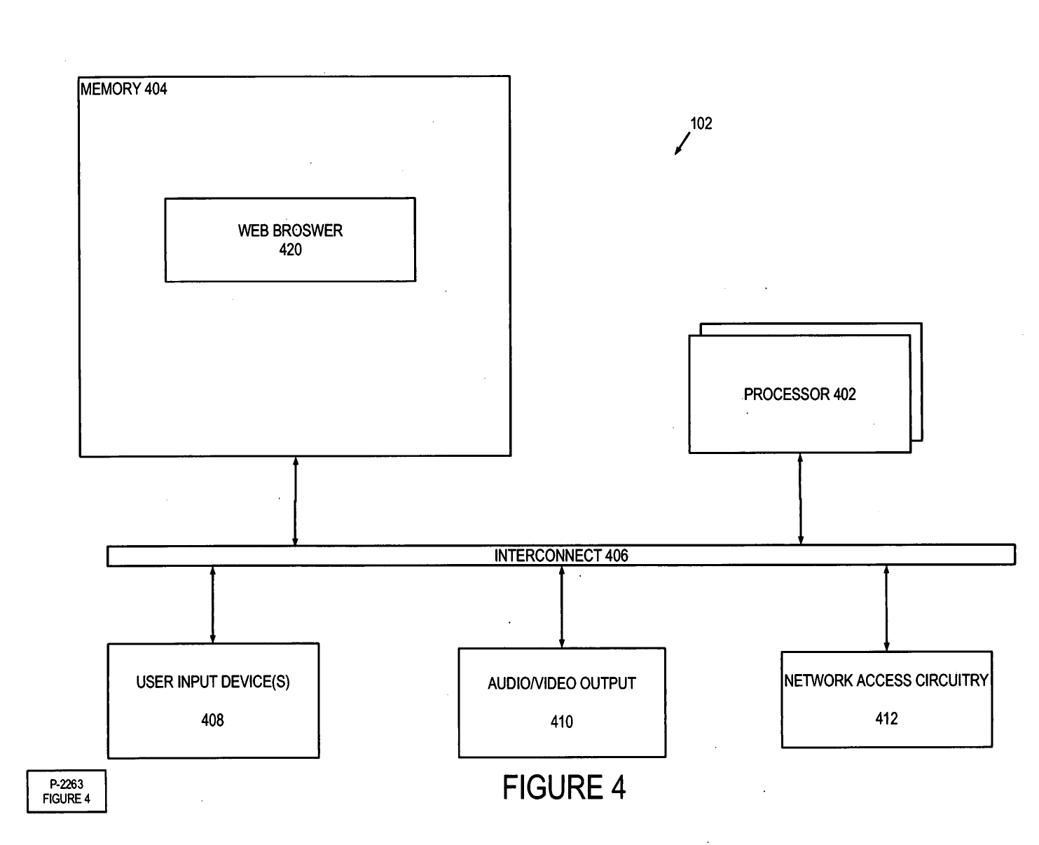

Hand-held computer 102 is generally of the architecture shown in FIG. 4. Hand-held computer 102 includes one or more microprocessors 402, each of which retrieves data and/or instructions from memory 404 and executes retrieved instructions in a conventional manner. Memory 404 can include generally any type of computer-readable memory such as randomly accessible memory (RAM), read-only memory (ROM), and persistent storage media such as magnetic and/or optical disks and portable forms of flash memory.

Microprocessors 402 and memory 404 are connected to one another through an interconnect 406 which is a bus in this illustrative embodiment. Interconnect 406 is also connected to one or more user input devices 408, one or more output devices 410, and network access circuitry 412. Input devices 408 generate signals in response to physical manipulation by a human user and include, for example, electronic mice, trackballs, touch pads, keyboards, keypads, speech recognition logic, and touch-sensitive screens. In this illustrative embodiment, input devices 408 include touch-sensitive screen 204 (FIG. 2), keyboard 206, buttons 208, and a microphone jack (not shown but a known component of the Zaurus SL-5500). Output devices 410 (FIG. 4) present information to the human user and include typical computer display devices such as CRTs, LCDs, and touch-sensitive screens and can also include audio output devices such as sound circuitry and loudspeakers. In this illustrative embodiment, output devices 410 include touch-sensitive screen 204 (FIG. 2) and a headphone jack (not shown but a known component of the Zaurus SL-5500). Network access circuitry 412 (FIG. 4) can be generally any network connection such as a modem or any type of ethernet network adapter for example. Of course, in this illustrative embodiment, network access circuitry 412 is a wireless network adapter, many of which are currently available for the Zaurus SL-5500.

To retrieve and display parking payment status map 100, memory 404 includes a web browser 420 which is all or part of one or more computer processes executed by microprocessors 402 from memory 404. Web browsers are known and not described herein except where helpful in describing this illustrative embodiment. It should be noted that, by selecting an ordinary web browser as the viewer of parking payment status map 100, virtually any computing device capable of executing a functional web browser can be used as hand-held computer 102.

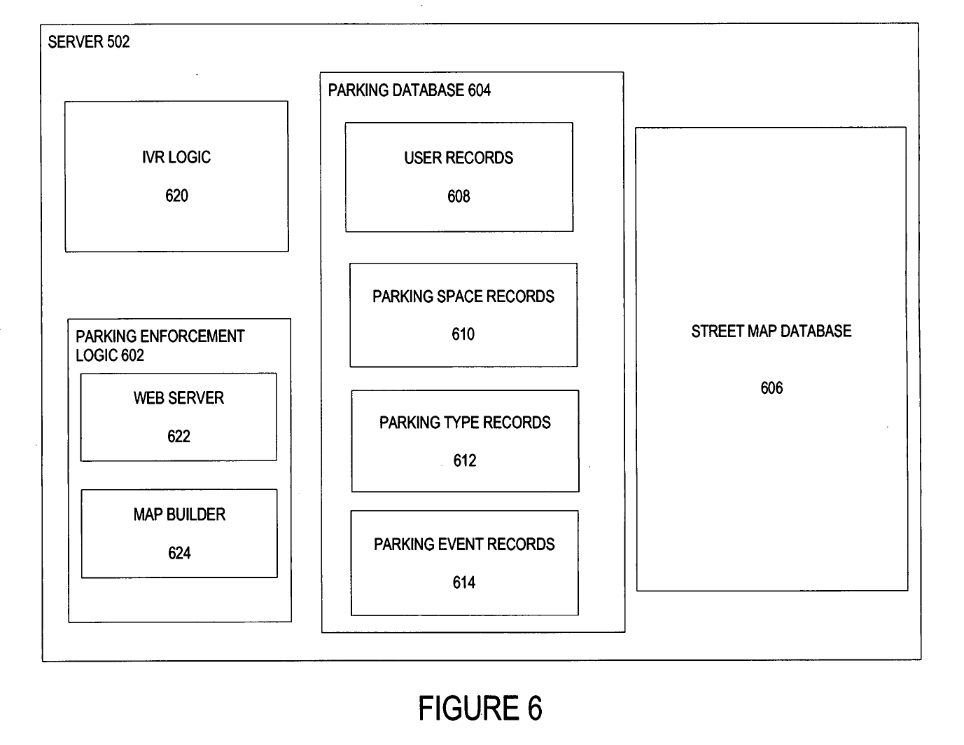

Server 502 is generally of the conventional physical architecture described above with respect to FIG. 4. However, as a server, server 502 has a reduced need for user input and output devices since server 502 primarily provides services to other computer systems and generally interacts with a user only for maintenance purposes. Of course, computers designed for interactive use by a human user can also serve as server 502. Components of server 502 are shown in FIG. 6.

Parking enforcement logic 602 is a collection of computer instructions and data which collectively define the behavior of server 502 in serving requests for services related parking payment. Server 502 includes interactive voice response (IVR) logic 620 which accepts and serves requests for parking payment services. Generally, IVR logic 620 receives and serves requests from motorists to initiate or terminate payment for a particular parking space. Parking enforcement logic 602 includes a web server 622 which receives and serves requests according to the hypertext transport protocol (HTTP) and the hypertext transport protocol secure (HTTPS). HTTP and HTTPS are conventional and known and are not described herein.

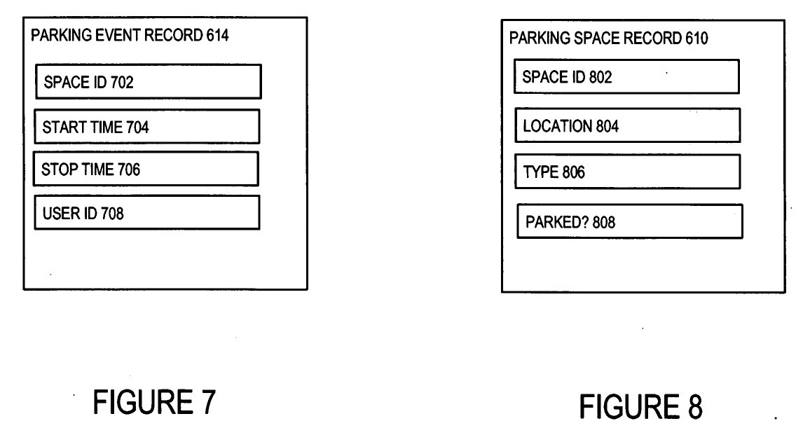

Server 502 also includes a parking database 604 and a street map database 606. Parking database 604 includes user records 608, parking space records 610, parking type records 612, and parking event records 614. User records 608 represent individual motorists who can pay for parking through server 502. User records 608 generally include information regarding payment methods of each user (e.g., prepaid accounts with account balance information) and information by which each user can be identified (e.g., a telephone number from which the user will access server 502 through IVR logic 620). Parking space records 610 represent individual parkings spaces managed by server 502. Parking type records 612 represent various classifications of parking spaces, each of which has its own parameters such as hours of enforcement, rates, etc. Parking event records 614 represent events in which users initiate or terminate payment for parking. Parking event records 614 and parking space records 610 are described below in conjunction with FIGS. 7 and 8, respectively.

Street map database 606 contains data which represents street layout information in a geographic region in which server 502 manages parking payment. Street map database 606 can be conventional such as the street map databases used by MapQuest, which is a wholly owned subsidiary of America Online, Inc. and which is based in Denver, Colo. and Mountville, Pa.

FIG. 7 shows an individual one of parking event records 614. Parking event record 614 includes a space identifier 702, a start time 704, a stop time 706, and a user identifier 708. Space identifier 702 uniquely identifies the parking space to which the represent parking event pertains within the parking spaces of parking space records 610 (FIG. 6). Start time 704 and stop time 706 represent start and stop times, respectively, of payment for parking in the space identified by space identifier 702. In an alternative embodiment, a single time is represented in a parking event record and data represents whether the time is for starting payment or stopping payment. In this alternative embodiment, two parking event records represent an entire parking payment transaction. User identifier 708 uniquely identifies the motorist paying for parking within user records 608.

Upon initiation of parking by a motorist, a parking event record such as parking event record 614 is created. Space identifier 702 represents a parking space specified by the motorist. Start time 704 represents the current time. Stop time 706 is null since payment is active. And, user identifier 708 identifies the motorist. Upon termination of parking by the motorist, the parking event record is modified such that stop time 706 represents the then current time.

FIG. 8 shows an individual one of parking space records 610. Parking space record 610 includes a space identifier 802 which uniquely identifies a parking space within the parking spaces of parking space records 610 (FIG. 6). Location 804 specified the geographical location of the parking space. Location 804 can use generally any geographical location data which is meaningful within street map database 606 (FIG. 6). For example, latitude and longitude coordinates or a nearest street address are acceptable location data types. Type 806 identifies a type of parking space by identifying one of parking type records 612. Parked flag 808 indicates whether the parking space is currently paid for.

For enforcement purposes, the importance of the data stored by server 502 is that, through server 502, a parking control officer can identify specific parking spaces, determine where those parking spaces are located, and determine whether those parking spaces are paid for such that parking is authorized therein. Specifically, server 502 has sufficient information to create the representations of parking spaces shown in parking payment map 100 (FIGS. 1-3).

As for represented locations of individual meters, parking enforcement logic 602 (FIG. 6) superimposes rectangular shapes over a map of a particular region using location data of street map database 606 and location data of each parking space as represented in location 804. In a graphical representation, the rectangular shapes are rotated to align with the direction of the street on which the parking space is located and are translated (i.e., shifted spatially) to be adjacent to an edge of the street to represent the side of the street on which the parking space can be found. Such adjusts for any small errors in location determination such that no parking space is shown to be in the middle of a street or on a sidewalk.

As for determining whether a specific parking space is paid for and occupation thereof is authorized, parking enforcement logic 602 refers to parked flag 808 of the parking space record representing the specific parking space. Parked flag 808 is set each time payment for parking in the space is initiated and is cleared each time payment for parking in the space is terminated.

In an alternative embodiment, parked flag 808 is omitted and parking enforcement logic 602 (FIG. 6) determines the payment state of respective parking spaces by reference to parking event records 614. For example, if parking enforcement logic 602 finds a particular parking space corresponds to a parking event record which has a null stop time 706, the parking space is determined to be in a paid state. If no such parking event record exists in parking event records 614, parking enforcement logic 602 determines that the parking space is in an unpaid state.

As described above, in one embodiment, parking event records can have only a single time record and a type indicator which indicates whether the time corresponds to a start event or a stop event. In this embodiment, parking enforcement logic 602 determines that a particular parking space is in a paid state when parking event records 614 includes a record representing initiation of payment for parking and does not include a record representing termination of payment for the same space by the same user. Otherwise, if all payment starting records have corresponding payment stopping records, parking enforcement logic 602 determines that the parking space is in an unpaid state.

Of course, many other techniques can be used to determine whether a particular parking space is in a paid state rather than an unpaid state.

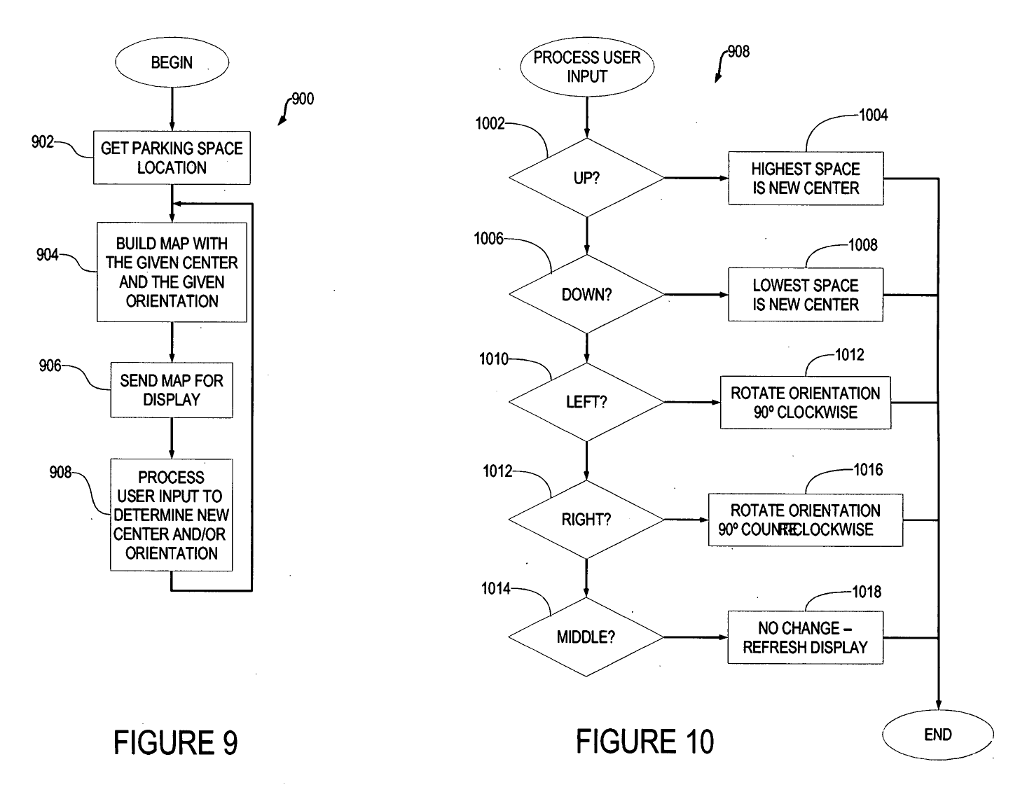

Logic flow diagram 900 (FIG. 9) illustrates the behavior of parking enforcement logic 602 in managing parking payment map 100 for a parking control officer using hand-held computer 102. In step 902, parking enforcement logic 602 gets an initial location of the parking control officer. Initial location information can be provided by Global Positioning Satellite (GPS) receiver in hand-held computer 102 or, if hand-held computer 102 includes a GPRS network adapter, by wireless telephone location technology available from TruePosition, a Liberty Media Company. This wireless telephone location technology is sometimes referred to as E911 service.

Despite availability of such automated location determination technologies, parking enforcement logic 602 requires that the parking control officer manually enter some location specifying data initially in this illustrative embodiment. Such enables hand-held computer 102 to serve as a remote parking enforcement terminal without any special software—without anything more than a standard web browser. The parking control officer can enter a nearby street address in the manner that users enter street addresses in MapQuest's map service. By reference to street map database 606, parking enforcement logic 602 can estimate the location of the parking control officer. Alternatively, the parking officer can specify an approximate location by entering an identifier of a nearby parking space. Parking enforcement logic 602 estimates the location of the parking control officer by reference to location 804 of the parking space record 610 of the identified parking space.

In preparing parking payment map 100, parking enforcement logic 602 uses a map center and a map orientation. The map center is initialized to be the estimated location of the parking control officer as determined in step 902. The map orientation is initially North.

In step 904, parking enforcement logic 602 builds data specifying parking payment map 100 having the map center and the map orientation. In building the data specifying the map, parking enforcement logic 602 collects locations of nearby parking spaces, payment states of those parking spaces, and street map data.

Parking payment map 100 is a text-only map, constructed entirely of textual data in the form of a HTML (hypertext markup language) document using text, tables, and and background colors. There are two advantages of such a map. First, textual representation is more compact than graphical representations and therefore less data is required to travel to hand-held computer 102 to properly represent the general locations and payment states of a number of parking spaces. Second, textual representation such as parking payment map 100 is compatible with very simple text-only web browsers, such as the lynx or www text-only web browsers which can be found in embedded system devices running a reduced Linux kernel.

As graphics-capable hand-held computers which are ruggedized for all-day professional use become more widely available and as bandwidth for widely dispersed wireless connections improves and becomes less expensive, graphical representations of parking payment map 100 can be more easily used.

In building parking payment map 100, parking enforcement logic 602 includes user interface objects in the map by which the parking control officer using hand-held computer 102 can request a new map from server 502—perhaps with a different map center or a different map orientation. In the text-only embodiment, such user interface objects can include hypertext links associated with labels such as “up,” “down,” “left,” “right,” “refresh,” “back,” and “forward.” In a graphical representation, the graphical representation of the map can be a mapped image in which clicking on the image provides coordinate information of the position at which the map is clicked. Processing of either type of user interface objects is described more completely below.

In step 906, web server 622 (FIG. 6) of parking enforcement logic 602 sends the map to hand-held computer 102 for display to the parking control officer. In this illustrative embodiment, the map is in the form of an HTML document to be displayed by web browser 220 (FIG. 2), complete with any included user interface objects. From the perspective of web server 622, a request from web browser 220 (FIG. 2) has been completely served and no more is required. The parking control officer is free to walk or drive along the street and comparing represented payment states of parking payment map 100 to observed parking space occupancy.

Eventually, the parking control officer will have enforced parking regulations in the area represented within parking payment map 100. At such time, the parking control officer actuates one of the user interface objects within parking payment map 100. For example, if the parking control officer is progressing northward along Main Street past Second Avenue, the parking control officer actuates the “up” object. As described above, the user interface objects can be hypertext links or an image map. In another embodiment, user interface objects are associated with the five directions of rocker button 202—namely, up, down, left, right, and center.

Parking enforcement logic 602 (FIG. 6) processes user input through any of the user interface objects in step 908. Step 908 is shown in greater detail in logic flow diagram 908 (FIG. 10).

Test step 1102 represents actuation of an “up” object by the parking control officer. The “up” object can be a hypertext link labeled “up,” a mapped region at the top of parking control map 100 which is actuated by touching touch-sensitive screen 204 in that region, or actuation of rocker button 208 in the up direction. In step 1004, parking enforcement logic 602 modifies the map center to correspond to the location of the uppermost parking space in parking payment map 100.

In this illustrative embodiment, the effect of the “up” object is embedded in the object itself. To facilitate understanding and appreciation of this point, it is made in the context of a simple hypertext link labeled “up.” When parking enforcement logic 602 includes the user interface object for an “up” gesture, parking enforcement logic 602 determines exactly what effect that gesture will have and embeds the state change of the map in the user interface object. In this embodiment, the hypertext link includes a URI (uniform resource indicator) of the form, “http://www.server502.com/p-e-logic602.cgi?center=2002&orientation=north”. In this URI, server 502 is identified by “www.server502.com,” parking enforcement logic 602 is identified by “p-e-logic.cgi,” parking space 2002 (shown in parking payment map 100) is the map center, and the map orientation is North. Thus, while parking payment map 100 has parking space 1904 as its map center, actuation of the “up” object requests a new map in which the map center is parking space 2002. Thus, the real processing of an “up” gesture is done partly in the configuration of the “up” user interface object in step 904 and by parsing the received URI in step 910 as described below. Processing of steps 1006-1020 are analogous except for the different substantive effects described below.

In response to a “down” gesture as detected in test step 1006, parking enforcement logic 602 modifies the map center in step 1008 to the lowest represented parking space of parking payment map 100. Thus, “up” and “down” gestures allow the parking control officer to effectively pan the view provided by parking payment map 100.

In response to a “left” gesture as detected in test step 1010, parking enforcement logic 602 modifies the map orientation in step 1012 clockwise by 90°. In the context of parking payment map 100, parking space 0902 is the new map center and the view is along First Avenue to the West.

In response to a “right” gesture as detected in test step 1014, parking enforcement logic 602 modifies the map orientation in step 1016 counterclockwise by 90°. In the context of parking payment map 100, parking space 0831 is the new map center and the view is along First Avenue to the East.

Thus, “left” and “right” gestures allow the parking control officer to effectively turn a corner to proceed down another street and accordingly update the view provided by parking payment map 100.

In response to a “center” gesture as detected in test step 1018, parking enforcement logic 602 makes no change to parking payment map 100 in step 1020. In effect, this is a “refresh” function. Such allows the parking control officer to verify the payment state of a particular parking space one more time before writing a citation for a parking violation.

After any of steps 1004, 1008, 1012, 1016, and 1020, processing according to logic flow diagram 908, and therefore step 908 (FIG. 9), completes. After step 908, processing transfers to step 904 in which parking enforcement logic 602 builds a new map with the new map center and map orientation in the manner described above, including user interface objects as described above.

Thus, the parking control officer's experience in verifying parking payment is quite simple and intuitive. To start, the parking control officer enters a location. Thereafter, the parking control officer visually compares payment states represented in parking payment map 100 with observed space occupancy. If a space appears in an unpaid state in parking payment map 100, the parking control officer can observe a conventional parking meter at the space to determine whether payment was made by use of the parking meter. Existing parking meters therefore can coexist with parking enforcement according to the present invention.

To see payment states of parking spaces ahead, the parking control officer simply clicks an “up” link. To backtrack and see payment states of parking spaces behind, the parking control officer simply clicks a “down” link. To turn left and see payment states of parking spaces in that direction, he parking control officer simply clicks a “left” link. To turn right and see payment states of parking spaces in that direction, he parking control officer simply clicks a “right” link. To update payment states of parking space already shown in parking payment map 100, the parking control officer simply clicks a “refresh” link.

While a few user interface embodiments have been described, it is appreciated that various combinations can be used in conjunction. For example, a mapped image can enable the parking control officer to request re-centering the map at the point touched while hypertext links are used for “left” and “right” gestures. In addition, some or all hypertext links can have graphical image labels rather than textual labels. Furthermore, some hand-held computers allow buttons, e.g., any of buttons 208, to be programmed with web browser functionality.

The above description is illustrative only and is not limiting. Instead, the present invention is defined solely by the claims which follow and their full range of equivalents.

What is claimed is:

1. A method for representing parking status of two or more parking locations which are related to one another spatially, the method comprising:
determining respective status of each of the two or more parking locations;
displaying a representation of each of the two or more parking locations wherein the respective representations are oriented according to the spatial relations of the two or more parking locations and further wherein the representation of each of the two or more parking locations indicates the respective status of each of the parking locations.

2. The method of claim 1 wherein the status of each of the two or more parking locations includes payment status.

3. The method of claim 2 wherein the payment status is selected from a group consisting of a paid state and an unpaid state.

4. The method of claim 1 wherein the representation of each of the parking locations identifies the respective parking location from among the two or more parking locations.

5. The method of claim 1 wherein displaying comprises:
sending representation data to a remote device such that the remote device renders the representation data as a display.

6. The method of claim 5 wherein the representation data is textual.

7. The method of claim 5 wherein the representation data is viewable through a web browser.

8. The method of claim 7 wherein the representation data comports with a hypertext markup language.

9. The method of claim 1 further comprising:
displaying one or more landmarks in spatial relation to the representations of the parking locations.

10. The method of claim 9 wherein the one or more landmarks include one or more streets.

11. The method of claim 9 wherein the one or more landmarks include one or more street intersections.

12. The method of claim 1 wherein the two or more parking locations are selected with reference to an initial location.

13. The method of claim 12 wherein the initial location is specified by a user.

14. The method of claim 12 wherein the initial location is indicated by a parking location identified by a user.

15. The method of claim 1 wherein the two or more parking locations are selected according to a reference location, the method further comprising:
selecting a new reference location in accordance with signals received from a user; and
repeating the step of displaying in accordance with the new reference location.

16. The method of claim 1 wherein displaying comprises displaying with a directional orientation, the method further comprising:
receiving signals from a user which specify a different directional orientation; and
repeating the step of displaying in accordance with the different directional orientation.

17. The method of claim 1 further comprising:
receiving signals from a user;
in response to the signals, repeating the steps of determining and displaying.

18. A computer readable medium useful in association with a computer which includes a processor and a memory, the computer readable medium including computer instructions which are configured to cause the computer to represent parking status of two or more parking locations which are related to one another spatially by:
determining respective status of each of the two or more parking locations;
displaying a representation of each of the two or more parking locations wherein the respective representations are oriented according to the spatial relations of the two or more parking locations and further wherein the representation of each of the two or more parking locations indicates the respective status of each of the parking locations.

19. The computer readable medium of claim 18 wherein the status of each of the two or more parking locations includes payment status.

20. The computer readable medium of claim 19 wherein the payment status is selected from a group consisting of a paid state and an unpaid state.

21. The computer readable medium of claim 18 wherein the representation of each of the parking locations identifies the respective parking location from among the two or more parking locations.

22. The computer readable medium of claim 18 wherein displaying comprises:
sending representation data to a remote device such that the remote device renders the representation data as a display.

23. The computer readable medium of claim 22 wherein the representation data is textual.

24. The computer readable medium of claim 22 wherein the representation data is viewable through a web browser.

25. The computer readable medium of claim 24 wherein the representation data comports with a hypertext markup language.

26. The computer readable medium of claim 18 wherein the computer instructions are configured to cause the computer to represent parking status of the parking locations by also:
displaying one or more landmarks in spatial relation to the representations of the parking locations.

27. The computer readable medium of claim 26 wherein the one or more landmarks include one or more streets.

28. The computer readable medium of claim 26 wherein the one or more landmarks include one or more street intersections.

29. The computer readable medium of claim 18 wherein the two or more parking locations are selected with reference to an initial location.

30. The computer readable medium of claim 29 wherein the initial location is specified by a user.

31. The computer readable medium of claim 29 wherein the initial location is indicated by a parking location identified by a user.

32. The computer readable medium of claim 18 wherein the two or more parking locations are selected according to a reference location, further wherein the computer instructions are configured to cause the computer to represent parking status of the parking locations by also:
selecting a new reference location in accordance with signals received from a user; and
repeating the step of displaying in accordance with the new reference location.

33. The computer readable medium of claim 18 wherein displaying comprises displaying with a directional orientation, further wherein the computer instructions are configured to cause the computer to represent parking status of the parking locations by also:
receiving signals from a user which specify a different directional orientation; and
repeating the step of displaying in accordance with the different directional orientation.

34. The computer readable medium of claim 18 wherein the computer instructions are configured to cause the computer to represent parking status of the parking locations by also:
receiving signals from a user;
in response to the signals, repeating the steps of determining and displaying.

35. A computer system comprising:
a processor;
a memory operatively coupled to the processor; and
a parking status module (i) which executes in the processor from the memory and (ii) which, when executed by the processor, causes the computer to represent parking status of two or more parking locations which are related to one another spatially by:
determining respective status of each of the two or more parking locations;
displaying a representation of each of the two or more parking locations wherein the respective representations are oriented according to the spatial relations of the two or more parking locations and further wherein the representation of each of the two or more parking locations indicates the respective status of each of the parking locations.

36. The computer system of claim 35 wherein the status of each of the two or more parking locations includes payment status.

37. The computer system of claim 36 wherein the payment status is selected from a group consisting of a paid state and an unpaid state.

38. The computer system of claim 35 wherein the representation of each of the parking locations identifies the respective parking location from among the two or more parking locations.

39. The computer system of claim 35 wherein displaying comprises:
sending representation data to a remote device such that the remote device renders the representation data as a display.

40. The computer system of claim 39 wherein the representation data is textual.

41. The computer system of claim 39 wherein the representation data is viewable through a web browser.

42. The computer system of claim 41 wherein the representation data comports with a hypertext markup language.

43. The computer system of claim 35 wherein the parking status module, when executed by the processor, causes the computer to represent parking status of the parking locations by also:
displaying one or more landmarks in spatial relation to the representations of the parking locations.

44. The computer system of claim 43 wherein the one or more landmarks include one or more streets.

45. The computer system of claim 43 wherein the one or more landmarks include one or more street intersections.

46. The computer system of claim 35 wherein the two or more parking locations are selected with reference to an initial location.

47. The computer system of claim 46 wherein the initial location is specified by a user.

48. The computer system of claim 46 wherein the initial location is indicated by a parking location identified by a user.

49. The computer system of claim 35 wherein the two or more parking locations are selected according to a reference location, further wherein the parking status module, when executed by the processor, causes the computer to represent parking status of the parking locations by also:
selecting a new reference location in accordance with signals received from a user; and
repeating the step of displaying in accordance with the new reference location.

50. The computer system of claim 35 wherein displaying comprises displaying with a directional orientation, further wherein the parking status module, when executed by the processor, causes the computer to represent parking status of the parking locations by also:
receiving signals from a user which specify a different directional orientation; and
repeating the step of displaying in accordance with the different directional orientation.

51. The computer system of claim 35 wherein the parking status module, when executed by the processor, causes the computer to represent parking status of the parking locations by also:
receiving signals from a user;
in response to the signals, repeating the steps of determining and displaying.
